(19) United States
(12) Patent Application Publication
(10) Pub. No.: US 2026/0092693 A1
(43) Pub. Date: Apr. 2, 2026

(54) LIGHT ASSEMBLY FOR REFRIGERATOR

(71) Applicant: Whirlpool (China) Co., Ltd., Hefei (CN)

(72) Inventors: Dongkun Li, Hefei City (CN); Huasheng Yin, Hefei City (CN); Qian Hao, Hefei City (CN); Feng Zhang, Hefei City (CN)

(73) Assignee: Whirlpool (China) Co., Ltd., Hefei (CN)

(21) Appl. No.: 19/333,517

(22) Filed: Sep. 19, 2025

(30) Foreign Application Priority Data
Sep. 30, 2024 (CN) 202422301890.1

(51) Int. Cl. F21V 15/01; F21V 33/00; F21W 131/305

(52) U.S. Cl. CPC F21V 15/01; F21V 33/0044; F21W 2131/305

(57) ABSTRACT

A pre-embedded light housing assembly configured to engage a refrigerator ceiling includes an internal housing that is operably coupled with an external housing. The internal housing includes a bottom wall with a retention feature that snap-fittingly engages the refrigerator ceiling. A first side wall and a second side wall are arranged oppositely in a width direction with the bottom wall disposed therebetween. A peripheral flange is formed around the internal housing and contacts a periphery of the external housing. A light panel is provided on an outer surface of one of the first side wall or the second side wall.

### CROSS-REFERENCE TO RELATED APPLICATIONS

This application claims priority to Chinese Utility Model Application No. 202422301890.1, filed on Sep. 20, 2024, entitled “A kind of refrigerator ceiling light embedded box and its refrigerator,” the disclosure of which is hereby incorporated herein by reference in its entirety.

### BACKGROUND OF THE DISCLOSURE

The present disclosure relates to the technical field of refrigerators, and in particular to a refrigerator ceiling light embedded box and its refrigerator.

### BACKGROUND TECHNOLOGY

The refrigerator light embedded housing is a device used for embedded and foamed refrigerator lights. At present, the embedded housing for the ceiling light of the refrigerator product is punched in the upper part of the external housing, so that the ribs on the internal housing match the through holes in the upper part of the external housing, and then the device is fixed with tape around the contact between the embedded housing and the upper part of the external housing.

This kind of embedded housing has two shortcomings. For example, the embedded housing matches the through hole in the upper part of the external housing, which requires punching the external housing, which increases the difficulty of the process, and therefore can result in bubble leakage when the refrigerator is foamed. In order to prevent bubble leakage, tape is added around the contact between the embedded housing and the upper part of the external housing, which increases the product manufacturing process and increases the working hours.

The present disclosure aims to solve this technical problem by reducing the manufacturing process and the risk of leakage of the embedded, or internal housing of the refrigerator. Specifically, the design of the lamp pre-embedded internal housing and the external housing of the present disclosure being snap-fastened and the closely fitting flanges abutting the surrounding lamp internal housing and external housing, the ribs on the existing lamp internal and external housings are eliminated. It is a tedious process to properly fit the housing and then tape the housing to prevent leakage as with traditional configurations. Moreover, preventing leakage also increases the overall strength of the lamp housings. Further, by arranging the light panel on the outside of the lamp embedded internal housing, it effectively solves the problem of opening the refrigerator door and looking directly at the lamp beads, which increases the overall visual aesthetic of the refrigerator.

### SUMMARY OF THE DISCLOSURE

According to one aspect of the present disclosure, a pre-embedded light housing assembly configured to engage a refrigerator ceiling includes an internal housing that is operably coupled with an external housing. The internal housing includes a bottom wall with a retention feature that snap-fittingly engages the refrigerator ceiling. A first side wall and a second side wall are arranged oppositely in a width direction with the bottom wall disposed therebetween. A peripheral flange is formed around the internal housing and contacts a periphery of the external housing. A light panel is provided on an outer surface of one of the first side wall or the second side wall.

According to another aspect of the present disclosure, an internal light assembly for a refrigerator includes an internal housing that is embedded into a wall of the refrigerator. The internal housing includes a first side wall and a second side wall. A width of the first side wall is greater than a width of the second side wall. The internal housing further includes a light panel that is operably coupled with the first side wall and an arcuate bottom wall that has retention features. An external housing is operably coupled with the retention features of the arcuate bottom wall of the internal housing.

According to another aspect of the present disclosure, a refrigerator ceiling light embedded internal housing assembly includes a lamp embedded internal housing. The lamp embedded internal housing can be snapped and fixed with the inner liner of the refrigerator. The lamp embedded internal housing includes a bottom wall and a first side wall and a second side wall that are arranged oppositely in the width direction. The bottom wall, the first side wall, and the second side wall are surrounded to form a structure that is adapted to the housing. A light panel is provided on the outer surface of the first side wall or the second side wall and a flange is provided on the circumferential edge of the lamp embedded internal housing. The flange can be in contact with the circumferential contact surface of the housing.

Further, the width of the first side wall is greater than the width of the second side wall; the light panel is arranged on the outer surface of the first side wall; and the bottom wall is a curved surface.

Further, a pair of assembly grooves with opposite openings are provided on the outer surface of the first side wall, and a light panel is installed in the assembly grooves.

Furthermore, a plurality of light guide grooves are provided on the outer surface of the first side wall, and the plurality of light guide grooves are spaced apart along the length direction of the first side wall.

At least one protruding circular buckle is provided on the outer surface of the bottom wall; the circular buckle can be engaged with the external housing.

Further, the bottom wall is provided with a leakage hole, and the outer surface of the bottom wall is also provided with a first rib and a second rib, wherein:

The first rib is disposed on a side of the leakage hole away from the lamp panel, and the first rib can abut with the housing;

The second rib is provided on the side of the circular buckle away from the light panel, and the second rib can abut with the housing.

The first rib and the second rib have a U-shaped structure, and the opening directions of the first rib and the second rib are away from the light panel.

According to another aspect of the present disclosure, a refrigerator includes an inner liner and the refrigerator ceiling light embedded housing assembly. The refrigerator ceiling light embedded internal housing is snap-connected to the external housing and the flange of the refrigerator ceiling light embedded internal housing is connected to the refrigerator ceiling light external housing.

Further, a pre-embedded groove is formed in an inner recess of the internal housing, and the light panel is placed between the first side wall or the second side wall and the side wall of the pre-embedded groove. The circumferential edge of the pre-embedded groove is provided with a horizontally extending first platform surface and a vertically extending second platform surface. The second platform surface is located at an edge of the first platform surface away from the pre-embedded groove. The flange is attached to the second platform surface, and the end surface of the flange is in contact with the first platform surface.

The pre-embedded groove is provided with at least one circular hole, and the outer side of the bottom wall is provided with at least one protruding circular buckle, and the circular buckle is engaged with the circular hole.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an assembly diagram of the lamp embedded box and the box bladder of the present disclosure;

FIG. 2 is a schematic structural diagram of a lamp embedded box of the present disclosure;

FIG. 3 is a schematic structural diagram of a light panel of the present disclosure; and

FIG. 4 is a schematic structural diagram of a box of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a refrigerator, and more specifically to a light embedded in a liner of the refrigerator. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

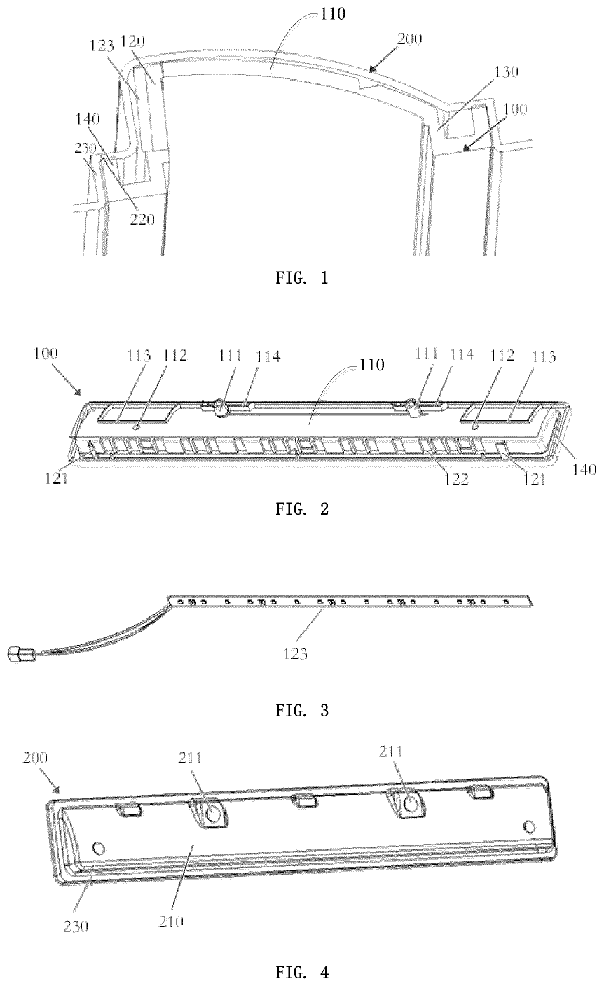

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

In order to make the technical solutions and technical effects of the present utility model clearer, the technical solutions in the embodiments of the present utility model will be clearly and completely described below in conjunction with the accompanying drawings in the embodiments. The described embodiments are the embodiments of the present disclosure. The present disclosure aims to provide a pre-embedded light assembly for a refrigerator ceiling light, which is used to solve the existing time-consuming process of pasting and fixing a traditional light assembly with tape to prevent leakage and the shortcomings of easy movement between the light pre-embedded internal housing and the external housing.

The refrigerator ceiling light assembly as set forth herein includes a lamp embedded internal housing 100. The lamp embedded internal housing 100 is snap-fitted with the external housing 200 of the refrigerator. It is contemplated that the external housing 200 may be part of the inner liner of the refrigerator and may be integral therewith. The internal housing 100 or the external housing 200 or both may include transparent or translucent qualities to allow light to pass through.

With reference to FIGS. 1 and 2, the lamp embedded internal housing 100 has a rectangular structure. The lamp embedded internal housing 100 includes a bottom wall 110 as well as first and second side walls 120, 130 that are oppositely arranged along the width direction. The first side wall 120 is larger, and more specifically, wider than the second side wall 130. The first side wall 120 and the second side wall 130 are surrounded by a flange structure that is adapted to engage the external housing 200. A light panel 123 is provided on the outer surface of the first side wall 120 or the second side wall 130. The circumferential edge of the lamp embedded internal housing 100 is also provided with a flange 140. The flange 140 can be in contact with the circumferential contact surface of the external housing 200.

The bottom wall 110 may include a curved surface. By optimizing the curved shape of the bottom wall 110 and the width dimensions of the first side wall 120 and the second side wall 130, it is possible to avoid looking directly at the lamp lights (which may be LEDs, incandescent bulbs, etc.) when opening the refrigerator door. This creates an ambient light configuration that provides a more aesthetically pleasing experience. Moreover, this configuration effectively ensures the projection angle and range of the light emitted by the light panel 123 meets desirable brightness requirements. When the curved surface structure is acted upon by an external force, it can evenly distribute the force to the entire curved surface, avoiding focused application of force. The concentration reduces the situation of excessive local stress. In addition, this force dispersion effect helps to improve the compression, bending and impact resistance of the lamp embedded internal housing 100. The curved design can also improve the stability of the lamp embedded internal housing 100. When the lamp embedded internal housing 100 is subjected to lateral forces or torque, the curved surface structure can better resist deformation and twisting and maintain its original shape and function.

With reference again to FIG. 2, retention features may be provide, which may include at least one protruding circular buckle 111 is provided on the outer surface of the bottom wall 110 to achieve snap-fitting engagement and fixation between the circular buckle 111 and the external housing 200. The circular buckle 111 forms a protrusion extending from the bottom wall 110.

The bottom wall 110 includes at least one leakage hole 112, as well as a first rib 113 and a second rib 114 provided on the outer surface of the bottom wall 110. The first rib 113 is provided on the side of the leakage hole 112 away from the lamp panel 123. The first rib 113 may be in contact with the external housing 200. The second rib 114 is provided on the side of the circular buckle 111 away from the light panel 123. Similarly, the second rib 114 may also be in contact with the external housing 200. Both the first rib 113 and the second rib 114 have a U-shaped structure. The opening ends of the U-shaped structure of the first rib 113 and the second rib 114 are positioned away from the lamp panel 123. The first rib 113 and the second rib 114 are designed to form a physical barrier on the outer side of the bottom wall 110 to prevent liquid leakage. The surfaces of the first and second ribs 113, 114 can be specially treated, such as by an addition of a coating or a change in the surface roughness, to increase their surface tension. In this way, even if a small amount of liquid crosses the physical barrier, it will be difficult to cross the ribs due to surface tension. The shape of the ribs also improves the blocking effect of the ribs 113, 114. Furthermore, the first ribs 113 and the second ribs 114 are designed with inclination angles or arcs. Such a design can maximize the contact area of liquid formed on the surface of the ribs, thereby using surface tension to prevent further penetration of the liquid.

In the configuration set forth herein, the lamp pre-embedded internal housing 100 and the external housing 200 are snap-fastened and combined at the first rib 113 and the second rib 114, thereby eliminating the traditional phenomenon of liquid leakage after the lamp pre-embedded internal housing 100 and the box bladder 200 are fixed. The process of further sticking with tape may be used.

The width of the first side wall 120 is greater than the width of the second side wall 130. The light panel 123 (FIG. 3) is disposed on the outer surface of the first side wall 120. A pair of assembly grooves 121 with opposite openings are provided on the outer surface of the first side wall 120, and the light panel 123 is installed in the assembly grooves 121. A plurality of light guide grooves 122 are also provided on the outer surface of the first side wall 120. The light panel 123 is arranged opposite to the light guide grooves 122. The plurality of light guide grooves 122 are spaced apart along the length direction of the first side wall 120.

With reference now to FIG. 3, the lamp panel 123 has a long and narrow rectangular structure, and a plurality of lamp lights are spaced on the lamp panel 123. This design of installing the lamp board 123 outside the lamp embedded internal housing 100 effectively solves the problem of looking directly at the lamp lights in traditional ceiling lamp embedded light assemblies, so that the user will not directly see the lamp beads when opening the refrigerator, and the overall aesthetic is improved.

Referring again to FIG. 2, the flange 140 is provided on the circumferential edge of the lamp embedded internal housing 100, and the flange 140 can be in contact with the circumferential contact surface of the external housing 200.

The configuration set forth herein also extends the protection of a refrigerator, which includes the external housing 200 and the above-mentioned refrigerator ceiling light embedded internal housing. The refrigerator ceiling light embedded internal housing is snap-connected to the external housing 200, and the flange 140 of the refrigerator ceiling light embedded internal housing is operably coupled with the external housing 200.

With reference now to FIG. 4, a pre-embedded groove 210 is formed in an inner cavity of the external housing 200 and the light panel 123 is placed between the first side wall 120 or the second side wall 130 and the side wall of the pre-embedded groove 210. The pre-embedded groove 210 is provided with at least one circular hole 211, and the outer side of the bottom wall 110 is provided with at least one protruding circular buckle 111, and the circular buckle 111 is locked and fixed with the circular hole 211. This coupling feature secures the internal housing 100 to the external housing 200.

Further, a peripheral or circumferential edge of the embedded groove 210 is provided with a horizontally extending first platform surface 220 and a vertically extending second platform surface 230. The second platform surface 230 is located away from the first platform surface 220 and away from the embedded groove 210. One side edge of the flange 140 is in contact with the second platform surface 230, and the end surface of the flange 140 is in contact with the first platform surface 220 to form a pre-tightening force or friction fit engagement. Although traditional lamp embedded light assemblies and box bladders are easy to mate, the positioning is inaccurate and prone to relative movement. This construction effectively solves this problem because the lamp embedded internal housing 100 and the external housing 200 are positioned accurately and the matching gap is very small. This also makes the weight and internal load of the lamp embedded internal housing 100 more evenly distributed on the overall structure. In addition, during long-term operation of the refrigerator, temperature changes and mechanical vibrations may cause the lamp embedded internal housing 100 to deform, and the tightly matched structure of the flange 140 and the second platform surface 230 can effectively resist these external influences and maintain form and function of the lamp embedded light assembly.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1-10. (canceled)

11. A pre-embedded light housing assembly configured to engage a refrigerator ceiling, the light housing assembly comprising:
an internal housing operably coupled with an external housing, the internal housing including:
a bottom wall having a retention feature that snap-fittingly engages said refrigerator ceiling;
a first side wall and a second side wall arranged oppositely in a width direction, wherein the bottom wall is disposed therebetween;
a peripheral flange formed around the internal housing and which contacts a periphery of the external housing; and
a light panel provided on an outer surface of one of the first side wall or the second side wall.

12. The pre-embedded light housing assembly of claim 11, wherein a width of the first side wall is greater than a width of the second side wall, and further wherein the light panel is arranged on the outer surface of the first side wall.

13. The pre-embedded light housing assembly of claim 11, further comprising:
a pair of assembly grooves with opposite openings are disposed on the outer surface of the first side wall, wherein the light panel is installed inside at least one of the assembly grooves.

14. The pre-embedded light housing assembly of claim 11, wherein the outer surface of the first side wall includes a plurality of light guide grooves, the plurality of light guide grooves being spaced apart along a length of the first side wall.

15. The pre-embedded light housing assembly of claim 11, further comprising:
at least one protruding circular buckle disposed on the outer surface of the bottom wall, wherein the circular buckle is snap-connected with the external housing.

16. The pre-embedded light housing assembly of claim 15, wherein the bottom wall includes at least one leakage hole, and wherein a first rib and a second rib are disposed at an outer side of the bottom wall.

17. The pre-embedded light housing assembly of claim 16, wherein the first rib is disposed on a side of the at least one leakage hole away from the light panel, and wherein the first rib forms a physical barrier on the outer side of the bottom wall to prevent liquid leakage.

18. The pre-embedded light housing assembly of claim 16, wherein the second rib is disposed on a side of the circular buckle away from the light panel, and wherein the second rib is in abutting contact with the external housing.

19. The pre-embedded light housing assembly of claim 16, wherein the first rib and the second rib both have a U-shaped structure, and wherein an opening of the U-shaped structure of the first and second ribs is positioned away from the light panel.

20. The pre-embedded light housing assembly of claim 18, wherein said light housing assembly is connected with the external housing via snap connection.

21. The pre-embedded light housing assembly of claim 20, wherein a pre-embedded groove is formed in an inner cavity of the external housing, and wherein the light panel is placed at the first side wall or between the second side wall and the pre-embedded groove.

22. The pre-embedded light housing assembly of claim 21, wherein a circumferential edge of the pre-embedded groove includes a horizontally extending first platform surface and a vertically extending second platform surface.

23. The pre-embedded light housing assembly of claim 22, wherein the vertically extending second platform surface is located at an edge of the horizontally extending first platform surface away from the pre-embedded groove.

24. The pre-embedded light housing assembly of claim 22, wherein the peripheral flange is attached to the vertically extending second platform surface, and wherein an end surface of the peripheral flange is in contact with the horizontally extending first platform surface.

25. The pre-embedded light housing assembly of claim 22, wherein the pre-embedded groove includes at least one circular hole and the outer surface of the bottom wall includes at least one protrusion, and wherein the circular buckle is engaged with the at least one circular hole.

26. An internal light assembly for a refrigerator, the internal light assembly comprising:
an internal housing embedded into a wall of said refrigerator, the internal housing including:
a first side wall and a second side wall, wherein a width of the first side wall is greater than a width of the second side wall;
a light panel operably coupled with the first side wall; and
an arcuate bottom wall having retention features; and
an external housing that is operably coupled with the retention features of the arcuate bottom wall of the internal housing.

27. The internal light assembly of claim 26, wherein a pre-embedded groove is formed in an inner cavity of the external housing, and wherein the light panel is placed at the first side wall or between the second side wall and the pre-embedded groove.

28. The internal light assembly of claim 26, wherein a circumferential edge of the pre-embedded groove includes a horizontally extending first platform surface and a vertically extending second platform surface.

29. The internal light assembly of claim 28, wherein the vertically extending second platform surface is located at an edge of the horizontally extending first platform surface away from the pre-embedded groove.

30. The internal light assembly of claim 28, wherein a peripheral flange is attached to the vertically extending second platform surface, and wherein an end surface of the peripheral flange is in contact with the horizontally extending first platform surface.
